(19) United States
(12) Patent Application Publication
(10) Pub. No.: US 2024/0123976 A1
(43) Pub. Date: Apr. 18, 2024

(54) VEHICLE CONTROLLER, METHOD, AND COMPUTER PROGRAM FOR VEHICLE CONTROL

(71) Applicant: TOYOTA JIDOSHA KABUSHIKI KAISHA, Toyota-shi (JP)

(72) Inventor: Ryusuke KURODA, Tokyo-to (JP)

(73) Assignee: TOYOTA JIDOSHA KABUSHIKI KAISHA, Toyota-shi (JP)

(21) Appl. No.: 18/224,132

(22) Filed: Jul. 20, 2023

(30) Foreign Application Priority Data
Oct. 18, 2022 (JP) 2022-166778

(51) Int. Cl. B60W 30/09

(52) U.S. Cl. CPC B60W 30/09; B60W 2420/42; B60W 2520/00; B60W 2554/80

(57) ABSTRACT

A vehicle controller includes a processor configured to detect a candidate object on a road surface ahead of a vehicle from an image representing surroundings of the vehicle generated by a camera provided on the vehicle, determine whether the orientation of the vehicle has deflected more than a predetermined angle, when the vehicle reaches the position of the detected candidate object, and control the vehicle to decelerate when the orientation of the vehicle has deflected more than the predetermined angle.

### FIELD

The present invention relates to a vehicle controller, a method, and a computer program for controlling a vehicle.

### BACKGROUND

A technique whereby an obstacle in an area around a vehicle is detected from a sensor signal obtained by a sensor mounted on the vehicle, and the result of detection is used for autonomous driving control of the vehicle has been proposed (see International Publication WO2018/179359A).

A vehicle control system described in WO2018/179359A recognizes the distribution of obstacles in a travel direction of a vehicle, and determines a target trajectory for each wheel of the vehicle, based on the recognized distribution of obstacles. The vehicle control system automatically drives the vehicle along the target trajectory.

### SUMMARY

An obstacle in the path of a vehicle may be an object of indefinite shape, color, and size, such as a fallen object or a pothole. Such an object may not be accurately detected from a sensor signal obtained by a sensor mounted on the vehicle, which may result in failure to control the vehicle appropriately.

It is an object of the present invention to provide a vehicle controller that can control a vehicle safely even if there is a difficult-to-detect object on the path of the vehicle.

According to an embodiment, a vehicle controller is provided. The vehicle controller includes a processor configured to: detect a candidate object on a road surface ahead of a vehicle from an image representing surroundings of the vehicle generated by a camera provided on the vehicle, determine whether the orientation of the vehicle has deflected more than a predetermined angle, when the vehicle reaches the position of the detected candidate object, and control the vehicle to decelerate when the orientation of the vehicle has deflected more than the predetermined angle.

In the vehicle controller, the processor preferably determines whether the candidate object is detected from a ranging signal generated by a range sensor mounted on the vehicle; and in the case where the candidate object is not detected from the ranging signal, the processor preferably controls the vehicle to decelerate when the orientation of the vehicle has deflected more than the predetermined angle.

In this case, when the candidate object is detected from the ranging signal, the processor preferably controls the vehicle so that the vehicle avoids the position of the candidate object.

According to another embodiment, a method for vehicle control is provided. The method includes detecting a candidate object on a road surface ahead of a vehicle from an image representing surroundings of the vehicle generated by a camera provided on the vehicle; determining whether the orientation of the vehicle has deflected more than a predetermined angle, when the vehicle reaches the position of the detected candidate object; and controlling the vehicle to decelerate when the orientation of the vehicle has deflected more than the predetermined angle.

According to still another embodiment, a non-transitory recording medium that stores a computer program for vehicle control is provided. The computer program includes instructions causing a processor mounted on a vehicle to execute a process including detecting a candidate object on a road surface ahead of the vehicle from an image representing surroundings of the vehicle generated by a camera provided on the vehicle; determining whether the orientation of the vehicle has deflected more than a predetermined angle, when the vehicle reaches the position of the detected candidate object; and controlling the vehicle to decelerate when the orientation of the vehicle has deflected more than the predetermined angle.

The vehicle controller according to the present disclosure has an advantageous effect of being able to control a vehicle safely even if there is a difficult-to-detect object on the path of the vehicle.

### BRIEF DESCRIPTION OF DRAWINGS

FIG. 1 schematically illustrates the configuration of a vehicle control system equipped with a vehicle controller.

FIG. 2 illustrates the hardware configuration of an electronic control unit, which is an embodiment of the vehicle controller.

FIG. 3 is a functional block diagram of a processor of the electronic control unit, related to a vehicle control process.

FIG. 4 is a diagram for explaining an example of the vehicle control process according to the embodiment.

FIG. 5 is a diagram for explaining another example of the vehicle control process according to the embodiment.

FIG. 6 is a diagram for explaining still another example of the vehicle control process according to the embodiment.

FIG. 7 is an operation flowchart of the vehicle control process.

### DESCRIPTION OF EMBODIMENTS

A vehicle controller, a method for vehicle control executed by the vehicle controller, and a computer program for vehicle control will now be described with reference to the attached drawings. The vehicle controller detects a candidate object on a road surface ahead of a vehicle from an image representing surroundings of the vehicle generated by an image capturing unit provided on the vehicle. In addition, the vehicle controller determines whether the orientation of the vehicle has just deflected more than a predetermined angle, based on images or sensor signals obtained by a motion sensor that detects motion of the vehicle, when the vehicle reaches the position of the detected candidate object. The vehicle controller controls the vehicle to decelerate when the orientation of the vehicle has just deflected more than the predetermined angle.

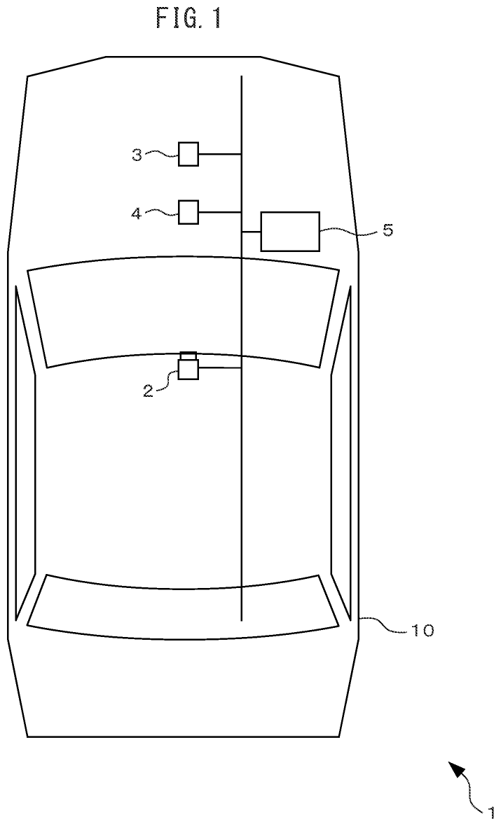

FIG. 1 schematically illustrates the configuration of a vehicle control system equipped with the vehicle controller. The vehicle control system 1 is mounted on a vehicle 10 and controls the vehicle 10. To achieve this, the vehicle control system 1 includes a camera 2, a range sensor 3, a motion sensor 4, and an electronic control unit (ECU) 5, which is an example of the vehicle controller. The camera 2, the range sensor 3, and the motion sensor 4 are communicably connected to the ECU 5. The vehicle control system 1 may further include a navigation device (not illustrated) for searching for a planned travel route to a destination, a GPS receiver (not illustrated) for determining the position of the vehicle 10, a storage device (not illustrated) that stores map information, and a wireless communication terminal (not illustrated) for wireless communication with a device outside the vehicle 10.

The camera 2 is an example of the image capturing unit that generates an image representing the surroundings of the vehicle 10. The camera 2 includes a two-dimensional detector constructed from an array of optoelectronic transducers, such as CCD or C-MOS, having sensitivity to visible light and a focusing optical system that forms an image of a target region on the two-dimensional detector. The camera 2 is mounted, for example, in the interior of the vehicle 10 so as to be oriented to the front of the vehicle 10. The camera 2 takes pictures of a region in front of the vehicle 10 every predetermined capturing period (e.g., 1/30 to 1/10 seconds), and generates images representing the region. Each image obtained by the camera 2 may be a color or grayscale image. The vehicle 10 may include two or more cameras taking pictures in different orientations or having different focal lengths.

Every time an image is generated, the camera 2 outputs the generated image to the ECU 5 via an in-vehicle network.

The range sensor 3 is an example of a distance measuring unit that generates a ranging signal indicating the distances to objects around the vehicle 10. The range sensor 3 may be configured as, for example, LiDAR, radar, or sonar. For each direction within a predetermined measurement range around the vehicle 10, the range sensor 3 generates ranging signals indicating the distance to an object in the direction at predetermined intervals. The range sensor 3 is preferably mounted on the vehicle 10 so that the measurement range of the range sensor at least partially overlaps the region captured by the camera 2. The vehicle 10 may include multiple range sensors having different measurement ranges.

Every time a ranging signal is generated, the range sensor 3 outputs the generated ranging signal to the ECU 5 via the in-vehicle network.

The motion sensor 4 is a sensor for detecting motion of the vehicle 10, and generates motion signals indicating predetermined motion of the vehicle 10 at predetermined intervals. In the present embodiment, the motion sensor 4 may be a yaw rate sensor for detecting the yaw rate of the vehicle 10. The motion sensor 4 may be a sensor that can measure the pitch rate of the vehicle 10 as well as the yaw rate of the vehicle 10, such as a gyro sensor having two or more axes.

The ECU 5 is configured to execute autonomous driving control of the vehicle 10 under a predetermined condition.

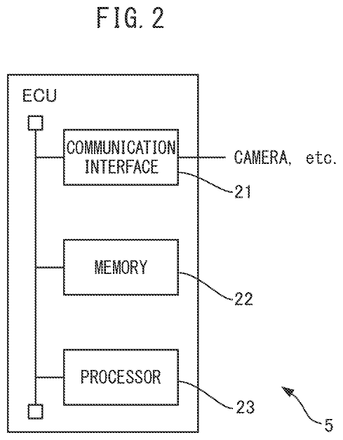

FIG. 2 illustrates the hardware configuration of the ECU 5, which is an example of the vehicle controller. As illustrated in FIG. 2, the ECU 5 includes a communication interface 21, a memory 22, and a processor 23. The communication interface 21, the memory 22, and the processor 23 may be configured as separate circuits or a single integrated circuit.

The communication interface 21 includes an interface circuit for connecting the ECU 5 to the camera 2, the range sensor 3, and the motion sensor 4. Every time an image is received from the camera 2, the communication interface 21 passes the received image to the processor 23. Every time a ranging signal is received from the range sensor 3, the communication interface 21 passes the received ranging signal to the processor 23. Every time a motion signal is received from the motion sensor 4, the communication interface 21 passes the received motion signal to the processor 23.

The memory 22, which is an example of a storage unit, includes, for example, volatile and nonvolatile semiconductor memories, and stores various types of data used in a vehicle control process executed by the processor 23 of the ECU 5. For example, the memory 22 stores parameters of the camera 2 indicating the focal length, the angle of view, the orientation, the mounted position, and the capture area as well as the measurement range of the range sensor 3. The memory 22 also stores a set of parameters for specifying a classifier for object detection, which is used for detecting an object in an area around the vehicle 10, such as an obstacle. In addition, the memory 22 temporarily stores sensor signals, such as images, ranging signals, and motion signals, and various types of data generated during the vehicle control process.

The processor 23 includes one or more central processing units (CPUs) and a peripheral circuit thereof. The processor 23 may further include another operating circuit, such as a logic-arithmetic unit, an arithmetic unit, or a graphics processing unit. The processor 23 executes the vehicle control process on the vehicle 10.

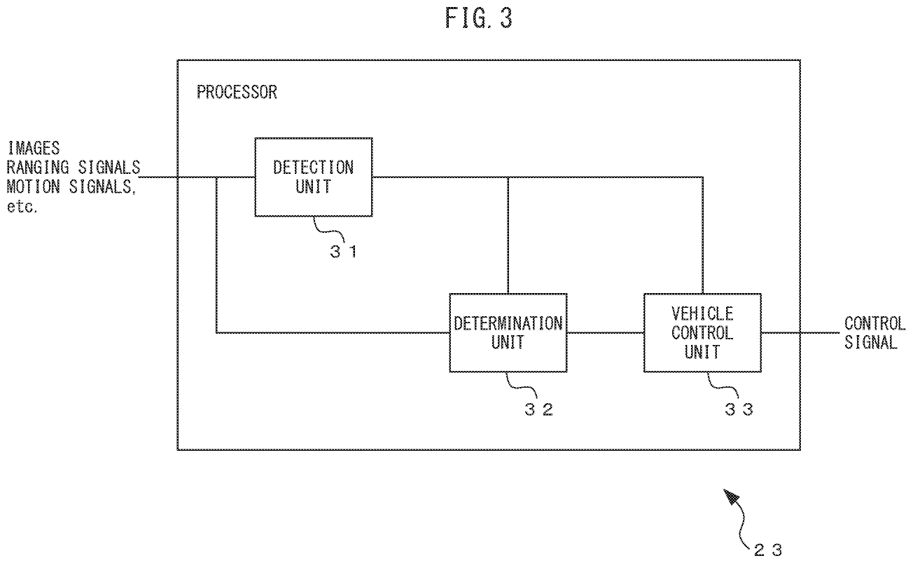

FIG. 3 is a functional block diagram of the processor 23, related to the vehicle control process. The processor 23 includes a detection unit 31, a determination unit 32, and a vehicle control unit 33. These units included in the processor 23 are functional modules, for example, implemented by a computer program executed by the processor 23, or may be dedicated operating circuits provided in the processor 23.

The detection unit 31 detects a candidate object on the road surface ahead of the vehicle 10 at predetermined intervals, based on the latest image received by the ECU 5 from the camera 2.

For example, the detection unit 31 detects a candidate object on the road surface by inputting the image obtained from the camera 2 into a first classifier that has been trained to detect an object on a road surface. In the present embodiment, an object to be detected on a road surface is, for example, a three-dimensional structure that should not exist on the road surface, such as a box fallen on the road surface, or a pothole formed in the road surface. As the first classifier, the detection unit 31 can use a deep neural network (DNN) having architecture of a convolutional neural network (CNN) type. More specifically, a DNN for semantic segmentation that identifies, for each pixel, an object represented in the pixel, e.g., a fully convolutional network (FCN) or U-net, is used as the first classifier. Alternatively, the detection unit 31 may use a classifier based on a machine learning technique other than a neural network, such as a random forest, as the first classifier. The first classifier is trained in advance in accordance with a predetermined training technique, such as backpropagation, with a large number of training images representing objects to be detected.

The detection unit 31 determines a set of pixels outputted by the first classifier and supposed to represent an object on the road surface as a candidate object region representing a candidate object on the road surface.

In addition, the detection unit 31 determines whether a candidate object on the road surface is detected at the real-space position corresponding to the candidate object region, based on a ranging signal. In this case also, the detection unit 31 detects a candidate object on the road surface by inputting a ranging signal into a second classifier that has been trained to detect an object on a road surface from a ranging signal. As the second classifier, the detection unit 31 can use a DNN having architecture of a CNN type or a self-attention network type. Alternatively, the detection unit 31 may detect a candidate object on the road surface in accordance with another technique to detect an object from a ranging signal.

Individual pixels of an image correspond one-to-one to the directions from the camera 2 to objects represented in the respective pixels. An object represented in a candidate object region is supposed to be on the road surface. Thus the detection unit 31 can estimate the real-space position of the object represented in the candidate object region relative to the position of the camera 2, using parameters of the camera 2 such as the height of the mounted position, the orientation, and the focal length. In addition, the detection unit 31 can estimate the direction, viewed from the range sensor 3, to the real-space position of the object represented in the candidate object region, based on the mounted positions of the camera 2 and the range sensor 3. Thus, when an object on the road surface is detected in the estimated direction by the second classifier from a ranging signal, the detection unit 31 determines that a candidate object on the road surface is detected at the real-space position corresponding to the candidate object region. In this case, the detection unit 31 detects the candidate object as a three-dimensional actual object on the road surface.

Every time a candidate object region is detected from an image, the detection unit 31 notifies the determination unit 32 of information indicating the position and area of the candidate object region in the image. When a candidate object on the road surface is detected from both an image and a ranging signal, the detection unit 31 further notifies the vehicle control unit 33 of the fact that a three-dimensional object is detected on the road surface and the real-space position of the object.

The determination unit 32 determines whether the orientation of the vehicle 10 has just deflected more than a predetermined angle, based on motion signals obtained by the motion sensor 4 or images obtained by the camera 2, when the vehicle 10 reaches the position of the candidate object on the road surface detected from an image.

For example, the determination unit 32 estimates the distance between the candidate object on the road surface and the vehicle 10, based on the position of the candidate object region in the image at the last detection of the candidate object from the image. As described in relation to the detection unit 31, individual pixels of an image correspond one-to-one to the directions from the camera 2 to objects represented in the respective pixels. An object represented in a candidate object region is supposed to be on the road surface. Thus the determination unit 32 can estimate the real-space position of the object represented in the candidate object region relative to the position of the camera 2, using parameters of the camera 2 such as the height of the mounted position, the orientation, and the focal length. Accordingly, the determination unit 32 determines that distance to the position of the candidate object on the road surface relative to the position of the camera 2, which is estimated from the position of the candidate object region in the image at the last detection of the candidate object, as the distance between the vehicle 10 and the candidate object.

The determination unit 32 estimates timing at which the vehicle 10 reaches the position of the candidate object on the road surface by dividing the distance between the candidate object and the vehicle 10 by the speed of the vehicle 10 measured by a vehicle speed sensor (not illustrated) mounted on the vehicle 10. In the following, the estimated timing at which the vehicle 10 reaches the position of the candidate object will be referred to simply as “estimated arrival timing.” The determination unit 32 determines whether the orientation of the vehicle 10 deflected more than a predetermined angle in a predetermined period (e.g., 1 to 2 seconds) before and after the estimated arrival timing.

For example, the determination unit 32 determines the variation in the orientation of the vehicle 10 in the yaw direction in the predetermined period before and after the estimated arrival timing, based on time-series motion signals received by the ECU 5 from the motion sensor 4. In the case where the variation in the orientation of the vehicle 10 in the yaw direction in the predetermined period is greater than a predetermined angle, the determination unit 32 determines that the orientation of the vehicle 10 deflected more than the predetermined angle when the vehicle 10 reached the position of the candidate object on the road surface detected from the image.

When the motion sensor 4 is a sensor that can detect a pitch rate, the determination unit 32 may determine the variation in the orientation of the vehicle 10 in the pitch direction in the predetermined period before and after the estimated arrival timing, based on time-series motion signals. In the case where the variation in the orientation of the vehicle 10 in the pitch direction in the predetermined period is greater than a predetermined angle, the determination unit 32 may determine that the orientation of the vehicle 10 deflected more than the predetermined angle when the vehicle 10 reached the position of the candidate object on the road surface detected from the image.

Alternatively, the determination unit 32 may determine the variation in the orientation of the vehicle 10 in the pitch direction in the predetermined period before and after the estimated arrival timing, based on time-series images received by the ECU 5 from the camera 2. In this case, the determination unit 32 determines a vanishing point for each of the images, and compares the variation in the position of the vanishing point in the vertical direction of the image in the predetermined period before and after the estimated arrival timing with the number of pixels corresponding to the predetermined angle. In the case where the variation in the position of the vanishing point is greater than the number of pixels corresponding to the predetermined angle, the determination unit 32 determines that the orientation of the vehicle 10 deflected more than the predetermined angle when the vehicle 10 reached the position of the candidate object on the road surface detected from the image.

To determine a vanishing point of an image, the determination unit 32 detects lane-dividing lines represented in the image. Specifically, the determination unit 32 detects lane-dividing lines by inputting the image into a third classifier that has been trained to detect lane-dividing lines. In this case, a classifier similar to the first classifier is used as the third classifier. The determination unit 32 executes a labeling process on sets of pixels representing lane-dividing lines and outputted by the third classifier to determine each set of such continuous pixels as an object region representing a single lane-dividing line. For each object region, the determination unit 32 determines a line approximating the lane-dividing line. Specifically, the determination unit 32 determines a line approximating the lane-dividing line for each object region so as to minimize the sum of squares of the distances to respective pixels in the object region. The determination unit 32 then determines an intersection point of the lines respectively approximating the lane-dividing lines as a vanishing point. In the case where three or more lane-dividing lines are detected and where their approximate lines do not intersect at a single point, the determination unit 32 determines the position at which the sum of the distances to the respective approximate lines is the smallest as a vanishing point.

The first classifier used by the detection unit 31 may be trained in advance to identify lane-dividing lines as well as a candidate object on the road surface. In this case, the determination unit 32 receives information indicating sets of pixels representing lane-dividing lines from the detection unit 31 for each image.

Alternatively, the determination unit 32 may determine the variation in the orientation of the vehicle 10 in the yaw or pitch direction in the predetermined period before and after the estimated arrival timing, based on time-series ranging signals received by the ECU 5 from the range sensor 3.

In this case, the determination unit 32 calculates cross-correlation values between two successive ranging signals as a function of displacement in the yaw or pitch direction. To this end, the determination unit 32 may use only measurement points whose distances in the ranging signals are greater than a predetermined distance for calculating the cross-correlation values so as not to be affected by a vehicle traveling in an area around the vehicle 10. The determination unit 32 determines the angle in the yaw or pitch direction where the cross-correlation value between two successive ranging signals is the largest as the variation in the orientation of the vehicle 10 in the yaw or pitch direction between the times of generation of the two ranging signals. The determination unit 32 then determines the sum of the variations in the orientation of the vehicle 10 determined between two successive ranging signals in the predetermined period as the variation in the orientation of the vehicle 10 at the time when the vehicle 10 reaches the position of the candidate object on the road surface.

In the case where the orientation of the vehicle 10 deflected more than the predetermined angle when the vehicle 10 reached the position of the candidate object on the road surface, the candidate object is likely to be an actual object on the road surface having a certain height. Further, the orientation of the vehicle 10 is assumed to have been changed by hitting the object. Thus, upon determining that the orientation of the vehicle 10 deflected more than the predetermined angle when the vehicle 10 reached the position of the candidate object on the road surface detected from the image, the determination unit 32 notifies the vehicle control unit 33 of the result of determination.

When notified by the determination unit 32 of the result of determination that the orientation of the vehicle 10 deflected more than the predetermined angle when the vehicle 10 reached the position of the candidate object on the road surface detected from the image, the vehicle control unit 33 controls components of the vehicle 10 to decelerate the vehicle 10 at a predetermined deceleration. In other words, the vehicle control unit 33 decelerates the vehicle 10, in the case where a candidate object on the road surface is detected from an image but not from a ranging signal, and where the orientation of the vehicle 10 deflected more than the predetermined angle when the vehicle 10 reached the position of the candidate object.

The vehicle control unit 33 sets the degree of accelerator opening or the amount of braking so as to decelerate at the set deceleration. The vehicle control unit 33 then determines the amount of fuel injection according to the set degree of accelerator opening, and outputs a control signal depending on the amount of fuel injection to a fuel injector of an engine of the vehicle 10. Alternatively, the vehicle control unit 33 controls a power supply of a motor for driving the vehicle 10 so that electric power depending on the set degree of accelerator opening is supplied to the motor. Alternatively, the vehicle control unit 33 outputs a control signal depending on the set amount of braking to the brakes of the vehicle 10.

When notified by the detection unit 31 that a three-dimensional object is detected on the road surface, the vehicle control unit 33 may control components of the vehicle 10 to avoid the position of the object. This enables the vehicle 10 to avoid hitting the object. In this case, the vehicle control unit 33 sets a planned trajectory to be traveled by the vehicle 10 so as to keep at least a predetermined distance from the real-space position of the object notified by the detection unit 31. The vehicle control unit 33 controls components of the vehicle 10 so that the vehicle 10 travels along the planned trajectory. For example, the vehicle control unit 33 determines the steering angle of the vehicle 10 for the vehicle 10 to travel along the planned trajectory, based on the planned trajectory and the current position of the vehicle 10, and outputs a control signal depending on the steering angle to an actuator (not illustrated) that controls the steering wheel of the vehicle 10. The vehicle control unit 33 determines the latest position of the vehicle 10 measured by a GPS receiver (not illustrated) mounted on the vehicle 10 as the current position of the vehicle 10. Alternatively, the vehicle control unit 33 may determine the distance traveled by the vehicle 10 and the variations in the travel direction of the vehicle 10 with respect to the position of the vehicle 10 at the time of setting of the planned trajectory, based on the acceleration and angular velocity of the vehicle 10 after the setting, thereby determining the current position of the vehicle 10. The acceleration and angular velocity of the vehicle 10 are measured by an acceleration sensor and a gyro sensor mounted on the vehicle 10, respectively.

The vehicle control unit 33 may further detect another object in an area around the vehicle 10 that may obstruct travel of the vehicle 10, such as another vehicle, a pedestrian, or a guardrail, based on an image received from the camera 2 or a ranging signal received from the range sensor 3. The vehicle control unit 33 detects such an object by inputting an image or a ranging signal into a classifier that has been trained to detect such an object. In this case, the vehicle control unit 33 sets a planned trajectory so as to keep at least a predetermined distance from the detected object.

When a planned trajectory that keeps at least a predetermined distance from the detected object cannot be set, the vehicle control unit 33 may control the vehicle 10 to stop before the three-dimensional object on the road surface. The vehicle control unit 33 may notify the driver that the vehicle will stop to avoid a collision, via a notification device provided in the vehicle interior, such as a display or a speaker.

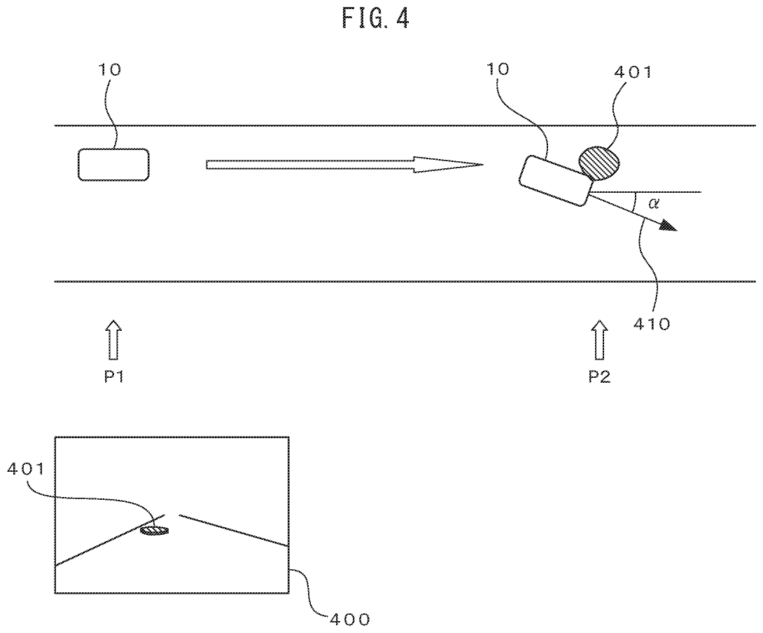

FIG. 4 is a diagram for explaining an example of the vehicle control process according to the present embodiment. In this example, a candidate object 401 on the road surface is detected at a position P2 ahead of the vehicle 10 from an image 400 generated by the camera 2 when the vehicle 10 is at a position P1. However, from ranging signals, the candidate object on the road surface is not detected at the position P2. Further, the deflection angle α of the orientation of the vehicle 10 indicated by an arrow 410 is greater than a predetermined angle when the vehicle 10 reaches the position P2 of the candidate object 401. Thus the candidate object 401 on the road surface is assumed to be a three-dimensional actual object on the road surface, and the vehicle 10 is controlled to decelerate.

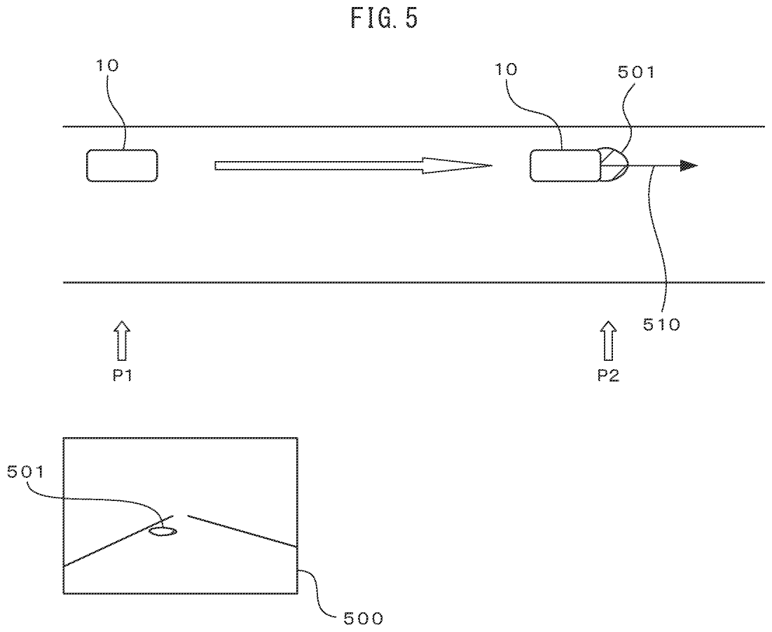

FIG. 5 is a diagram for explaining another example of the vehicle control process according to the present embodiment. In this example also, a candidate object 501 on the road surface is detected at a position P2 ahead of the vehicle 10 from an image 500 generated by the camera 2 when the vehicle 10 is at a position P1, as in the example illustrated in FIG. 4. From ranging signals, the candidate object on the road surface is not detected at the position P2. In this example, the orientation of the vehicle 10 indicated by an arrow 510 is unchanged when the vehicle 10 reaches the position P2 of the candidate object 501. Thus the candidate object 501 on the road surface is assumed to be actually a stain of the road surface or a marking drawn on the road surface. In this example, the vehicle 10 is not controlled to decelerate, and the speed of the vehicle 10 is maintained.

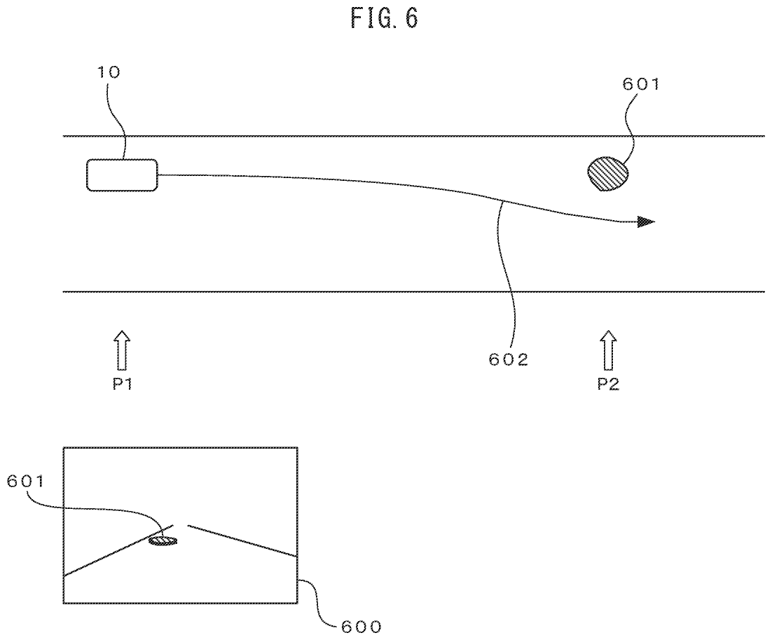

FIG. 6 is a diagram for explaining still another example of the vehicle control process according to the present embodiment. In this example also, a candidate object 601 on the road surface is detected at a position P2 ahead of the vehicle 10 from an image 600 generated by the camera 2 when the vehicle 10 is at a position P1, as in the example illustrated in FIG. 4. Further, from a ranging signal, the candidate object on the road surface is also detected at the position P2. Thus the vehicle 10 is controlled to travel along a trajectory indicated by an arrow 602 to avoid the position P2 of the candidate object 601.

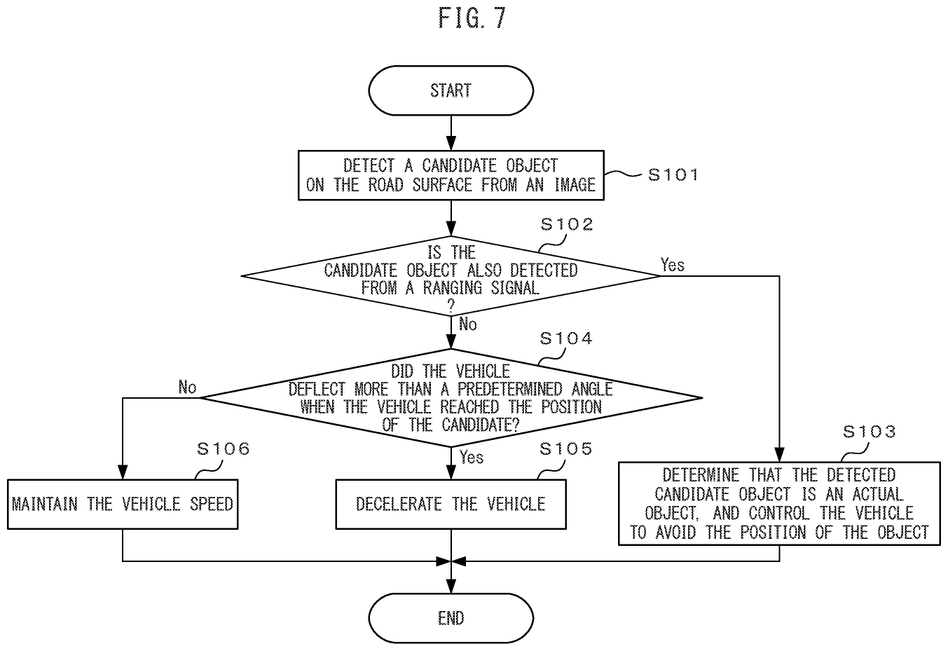

FIG. 7 is an operation flowchart of the vehicle control process executed by the processor 23. The processor 23 executes the vehicle control process at predetermined intervals in accordance with the operation flowchart described below.

The detection unit 31 of the processor 23 detects a candidate object on the road surface ahead of the vehicle 10, based on an image obtained by the camera 2 (step S101). When a candidate object is detected, the detection unit 31 determines whether the candidate object on the road surface is detected at the real-space position corresponding to a candidate object region representing the candidate object, based on a ranging signal (step S102). In the case where the candidate object on the road surface is also detected from a ranging signal (Yes in step S102), the candidate object is assumed to be a three-dimensional actual object on the road surface. Thus the vehicle control unit 33 of the processor 23 controls the vehicle 10 to avoid the real-space position of the assumed object (step S103).

In the case where the candidate object on the road surface is not detected from ranging signals (No in step S102), the determination unit 32 of the processor 23 determines whether the orientation of the vehicle 10 has just deflected more than a predetermined angle, when the vehicle 10 reaches the position of the candidate object (step S104). When the orientation of the vehicle 10 has just deflected more than a predetermined angle (Yes in step S104), the vehicle 10 is likely to have hit an actual object on the road surface corresponding to the candidate object. Thus the vehicle control unit 33 decelerates the vehicle 10 (step S105). When the variation in the orientation of the vehicle 10 is less than the predetermined angle (No in step S104), the candidate object is likely to be a stain of the road surface or a marking drawn on the road surface. Thus the vehicle control unit 33 maintains the speed of the vehicle 10 (step S106). Instead of maintaining the speed of the vehicle 10, the vehicle control unit 33 may continue control of the vehicle 10 that was being executed immediately before the arrival at the position of the candidate object. For example, in the case where the vehicle 10 was accelerating immediately before the arrival at the position of the candidate object, the vehicle control unit 33 may continue accelerating the vehicle 10 in step S106.

After step S103, S105, or S106, the processor 23 terminates the vehicle control process.

As has been described above, the vehicle controller detects a candidate object on a road surface ahead of a vehicle from an image representing surroundings of the vehicle generated by an image capturing unit provided on the vehicle. In addition, the vehicle controller determines whether the orientation of the vehicle has just deflected more than a predetermined angle, based on images or sensor signals obtained by a motion sensor that detects motion of the vehicle, when the vehicle reaches the position of the detected candidate object. The vehicle controller controls the vehicle to decelerate when the orientation of the vehicle has just deflected more than the predetermined angle. In this way, the vehicle controller can prevent the vehicle from falling into danger and control the vehicle safely even if an obstacle small in height from the road surface, which is difficult to detect with the range sensor mounted on the vehicle, is on the path of the vehicle. Further, the vehicle controller can prevent the vehicle from taking an unnecessary avoidance action even if, for example, a stain of the road surface represented in an image representing the surroundings of the vehicle is erroneously detected as an obstacle small in height from the road surface. This enables the vehicle controller to prevent vehicle control that makes the driver feel uncomfortable.

According to a modified example, in the case where a candidate object on the road surface is detected, the vehicle control unit 33 may increase the oil pressure of the brakes of the vehicle 10 before the vehicle 10 reaches the position of the candidate object. This enables the vehicle control unit 33 to apply the brakes immediately after the vehicle 10 hits the candidate object even if the object is a three-dimensional actual object on the road surface.

The vehicle control unit 33 may increase the oil pressure of the brakes of the vehicle 10 before the vehicle 10 reaches the position of a candidate object on the road surface, only if one of the following two conditions is satisfied.
(i) The shoulder of a road being traveled by the vehicle 10 has a width less than a predetermined width.
(ii) Another vehicle traveling on a lane adjacent to a host vehicle lane being traveled by the vehicle 10 is detected.

When the shoulder of a road being traveled by the vehicle 10 is narrow or when another vehicle is traveling on a lane adjacent to a host vehicle lane being traveled by the vehicle 10, a collision of the vehicle 10 with an object on the road surface may deflect the vehicle 10 and thereby compromise safety of the vehicle 10. By increasing the oil pressure of the brakes in advance, the vehicle control unit 33 can prevent compromising safety of the vehicle 10.

The vehicle control unit 33 detects a vehicle traveling on an adjacent lane by inputting an image obtained by the camera 2 or a ranging signal obtained by the range sensor 3 into a classifier that has been trained to detect a vehicle. At the detection, the vehicle control unit 33 determines whether the detected vehicle is traveling on an adjacent lane, based on the direction to the detected vehicle and, when the vehicle is detected from a ranging signal, the distance to the detected vehicle. Further, the vehicle control unit 33 identifies the width of the shoulder of the road being traveled by the vehicle 10, by referring to the position of the vehicle 10 measured by a GPS receiver mounted on the vehicle 10 and map information stored in the memory 22.

According to another modified example, the vehicle controller according to the present disclosure may be applied to a vehicle that is not equipped with a range sensor. In this case, the processing of steps S102 and S103 in the flowchart of FIG. 7 is omitted. More specifically, the vehicle control unit 33 decelerates the vehicle 10 in the case where a candidate object on the road surface is detected ahead of the vehicle 10, based on an image from the camera 2, and where it is determined that the orientation of the vehicle 10 deflected more than the predetermined angle when the vehicle 10 reached the position of the candidate object.

The computer program for achieving the functions of the processor 23 of the ECU 5 according to the embodiment or modified examples may be provided in a form recorded on a computer-readable portable storage medium, such as a semiconductor memory, a magnetic medium, or an optical medium.

As described above, those skilled in the art may make various modifications according to embodiments within the scope of the present invention.

What is claimed is:

1. A vehicle controller comprising:
a processor configured to:
detect a candidate object on a road surface ahead of a vehicle from an image representing surroundings of the vehicle generated by a camera provided on the vehicle,
determine whether the orientation of the vehicle has deflected more than a predetermined angle, when the vehicle reaches the position of the detected candidate object, and
control the vehicle to decelerate when the orientation of the vehicle has deflected more than the predetermined angle.

2. The vehicle controller according to claim 1, wherein the processor determines whether the candidate object is detected from a ranging signal generated by a range sensor mounted on the vehicle, and
in the case where the candidate object is not detected from the ranging signal, the processor controls the vehicle to decelerate when the orientation of the vehicle has deflected more than the predetermined angle.

3. The vehicle controller according to claim 2, wherein when the candidate object is detected from the ranging signal, the processor controls the vehicle so that the vehicle avoids the position of the candidate object.

4. A method for vehicle control, comprising:
detecting a candidate object on a road surface ahead of a vehicle from an image representing surroundings of the vehicle generated by a camera provided on the vehicle;
determining whether the orientation of the vehicle has deflected more than a predetermined angle, when the vehicle reaches the position of the detected candidate object; and
controlling the vehicle to decelerate when the orientation of the vehicle has deflected more than the predetermined angle.

5. A non-transitory recording medium that stores a computer program for vehicle control, the computer program causing a processor mounted on a vehicle to execute a process comprising:
detecting a candidate object on a road surface ahead of the vehicle from an image representing surroundings of the vehicle generated by a camera provided on the vehicle;
determining whether the orientation of the vehicle has deflected more than a predetermined angle, when the vehicle reaches the position of the detected candidate object; and
controlling the vehicle to decelerate when the orientation of the vehicle has deflected more than the predetermined angle.
